(19) United States
(12) Patent Application Publication
(10) Pub. No.: US 2026/0193436 A1
(43) Pub. Date: Jul. 9, 2026

(54) PROCESSES TO REMOVE CHLORINE FROM MIXED PLASTIC WASTE

(71) Applicant: SABIC GLOBAL TECHNOLOGIES B.V., Bergen op Zoom (NL)

(72) Inventors: Atul Pant, Houston, TX (US); Balamurali Krishna Nair, Missouri City, TX (US); Robert C. Schucker, Spring, TX (US); Jason Loiland, Sugar Land, TX (US); Ravichander Narayanaswamy, Bangalore (IN); Alexander Stanislaus, Bangalore (IN)

(21) Appl. No.: 19/132,493

(22) PCT Filed: Nov. 20, 2023
(86) PCT No.: PCT/EP2023/082362

§ 371 Date: May 23, 2025

(30) Foreign Application Priority Data
Nov. 29, 2022 (EP) 22210367.3

(51) Int. Cl. C08J 11/06; B29C 48/05; B29C 48/14; B29C 71/00; B29K 27/06; B29K 105/26

(52) U.S. Cl. CPC C08J 11/06; B29C 48/05; B29C 48/147; B29C 71/009; B29K 2027/06; B29K 2105/26; C08J 2327/06

(57) ABSTRACT

Methods of removing chlorine from a mixed plastic waste that can include a first polymer and a second chlorine containing polymer are described. A method can include heating a mixed plastic waste to obtain a melted mixed plastic waste stream. The melted mixed plastic waste stream can include melted plastic and hydrogen chloride (HCl) gas. The surface area of the melted mixed plastic stream can be increased such that at least a portion of the HCl is released from the melted mixed plastic waste stream and a first product stream is produced. The first product stream includes less chlorine when compared with the mixed plastic waste prior to heating.

### CROSS REFERENCE TO RELATED APPLICATIONS

This application claims priority to and the benefit of the filing date of European Patent Application No. 22/210,367, filed Nov. 29, 2022, which is incorporated herein by reference in its entirety.

### FIELD OF INVENTION

The invention generally concerns methods of removing of chlorine impurities from a mixed plastic waste. A method can include heating a mixed plastic waste to obtain a melted mixed plastic waste stream. The melted mixed plastic waste stream can include melted plastic and hydrogen chloride (HCl) that can be contained within the melted plastic. The surface area of the melted mixed plastic stream can be increased such that at least a portion of the HCl can be released from the melted mixed plastic waste stream and a first product stream can be produced. The first product stream can include less chlorine when compared with the mixed plastic waste prior to heating.

### BACKGROUND

Mixed plastic waste can originate from domestic and/or industrial sources. The composition of mixed plastic waste can include many types of plastic. For example, polyethylene terephthalate (PET), low-density or high-density polyethylene (PE), polypropylene (PP), polyvinyl chloride (PVC), polystyrene (PS) and other miscellaneous plastics coming from a variety of post-consumer products, (e.g., electronic waste, automobile waste, polyurethane foam packaging, carpet nylon, and the like). Other impurities such as trace metals as compounding additives to enhance performance from polymerization processes can also exist in mixed plastic waste. In addition, small amounts of non-plastics such as paper, wood, and/or food residue can be present.

Pyrolysis of waste mixed plastics is a process that includes decomposing plastics at a high temperature to produce a pyoil. Pyoil can be used directly as a liquid fuel or further processed for producing chemicals of high value. However, pyoil produced from mixed plastics generally contains a substantial amount of highly reactive chemicals, resulting in fast aging of the pyoil and/or formation of gums during transportation and further processing steps. Hence, it is fairly common for pyoil to foul containers and/or chemical processing units in which it is handled and/or processed with trace oxygen presented therein. Not all plastics are suitable to pyrolysis processing. For example, PVC can contain as much as 57% chlorine. Thus, conversion of chlorinated polymers can be undesirable due to the chloride derivatives formed that can harm downstream process metallurgy if left untreated. To remove plastics that contain chlorinated products, a sorting process can be applied in front of pyrolysis processes. However, sorting can be inefficient and costly.

Processes that describe removal of chloride containments from mixed plastic waste have been described. For example, U.S. Patent Application Publication No. 2022/0010213 to Sun et al., describes a process for pyrolysis of a mixed plastic stream that includes PVC. The process removes the chloride in a vapor reactor in the initial melting reactor. In another example, Japanese Patent Application No. JP2003231886 to Takeyoshi et al., describes a thermal decomposition process of waste plastic containing oil that suppresses generation of organic volatile substances and evaporates chlorine contained in the mixed plastic waste. In yet another example, International Application Publication No. WO 2021/087059 to Wu et al., describes dehalogenating a mixed waste plastic feed by heating the plastic-containing feed to a temperature sufficient to release a halogen-containing waste stream and then pyrolyzing the dehalogenated feed.

While methods for removing chlorine from mixed plastic waste exist, the need for improvements in this field persists.

### SUMMARY OF THE INVENTION

A solution to at least one of the problems associated with chlorine removal from mixed plastic waste has been discovered. In one aspect, a method of the present invention can include separating the steps of dehalogenation of PVC from devolatilization of HCl. For example, PVC decomposition can be accomplished in a reactor operating at high temperature and with a short-residence time. The polymer melt product can be manipulated to increase its surface area (e.g., formed into multiple strands/fibers or droplets). By increasing the surface area of the polymer melt, enhanced mass transfer (e.g., devolatilization) of HCl out of the polymer can be obtained. The HCl removal can be further aided by operating the devolatilization equipment either in vacuum or with a hot gas purge (e.g., nitrogen, (N₂), carbon dioxide (CO₂), or reactive gases like hydrogen hydrogen (H₂) gas, ammonia (NH₃) gas, or scrubbed HCl gas scrubbed/product gas from the process).

In one aspect of the present invention methods of removing chlorine from a mixed plastic waste that includes at least one chlorine containing polymer are described. A method can include (a) heating a mixed plastic waste that can include a first polymer (e.g., polyethylene (PE), polypropylene (PP), polyethylene terephthalate (PET), or polystyrene (PS), or any combination or blend thereof), and a second chlorine containing polymer (e.g., polyvinyl chloride (PVC), polyvinylidene chloride (PVDC), chlorinated polyethylene (CPE), chlorosulphonated polyethylene (CSM), or chloroendic acid polyester, or any combination or blend thereof) to obtain a melted mixed plastic waste stream. In a preferred aspect, the second chlorine containing polymer is PVC. The melted mixed plastic stream can include melted plastic and hydrogen chloride (HCl). The HCl can be included within the melted plastic. Heating and melting can be performed in an extruder (e.g., a single screw extruder, a twin screw extruder, or an auger extruder), a kneader, or a heat exchange unit that can include a static mixer, or batch reactor.

In step (b), the surface area of the melted mixed plastic waste stream can be increased to release at least a portion of the HCl from the melted mixed plastic waste stream; producing a first product stream. The HCl being released can be in the gas phase or the liquid phase, preferably the gas phase. Surface area increase can be performed in a container that is in fluid communication with the heating/melting unit (e.g., extruder, kneader, or heat exchange unit). For examples, a die can be positioned at an end of the extruder, the kneader, or the heat exchange unit, and the melted mixed plastic waste stream can flow through the die and into the container to form strands/fibers or droplets of the melted mixed plastic waste stream. The strands/fibers can preferably have a diameter of 5 millimetres (mm) or less, more preferably 1 mm or less. In some aspects, the strands/fibers can be formed into droplets. Surface area increase can be performed in the presence of a carrier gas that contacts the melted mixed plastic waste stream and carriers the HCl away from the melted mixed plastic waste stream. The carrier gas can be an inert gas (e.g., nitrogen (N₂) or carbon dioxide (CO₂), with N₂ being preferred), a reactive gas (e.g., preferably hydrogen (H₂) gas, ammonia (NH₃) gas, or scrubbed HCl free gas product gas obtained from the process for increasing the surface area), or a combination thereof. In another aspect, the surface area can be increased under vacuum. The surface increasing container can be a reactor that includes a first inlet for the melted mixed plastic waste stream, a second inlet for the carrier gas, a first outlet for the first product stream, and a second outlet for the carrier gas that can include the HCl obtained from the chlorine containing polymer. The second outlet can be positioned above the first outlet. In some embodiments, a horizontal extruder or a vertical extruder can be positioned above the first outlet for the first product stream. In another aspect, the container includes a conveyer belt that moves the strand/fibers through the container. In some aspects, the container can rotate.

The heating/melting and/or surface area increasing (e.g., steps (a) and (b)) can be each individually performed at least at a melt temperature of the mixed plastic waste up to 350° C., preferably 200° C. to 325° C. Optionally, a residence time for heating/melting and/or surface area increasing (e.g., steps (a) and (b)) can be 30 minutes or less, preferably 15 minutes or less. The first product stream can include less chlorine when compared with the melted mixed plastic waste and/or the original mixed plastic waste (e.g., step (a) mixed plastic waste). Increasing the surface area of the melted mixed plastic waste stream can include forming strands/fibers and/or droplets of the melted mixed plastic waste stream. In some aspects, the first product stream can be subjected to a depolymerization reaction to produce a second product stream that can include oligomers (e.g., oligomers having an average MW of less than 20,000 g/mol, preferably less than 10,000 g/mol) The second product stream can be further processed to remove insoluble materials, soluble organic materials, inorganic chloride, or a combination thereof, by way of filtration, centrifugation, decanting/sedimentation, and/or washing with water or caustic solution.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the methods of the present invention are their abilities to remove chlorine from mixed plastic waste.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 shows a schematic of a chlorine removal system using the methods of the present invention. The system includes an dehalogenation unit (e.g., a reactor) positioned upstream and perpendicular to a volatization unit (e.g., a container).

FIG. 2 shows a schematic of a chlorine removal system using the methods of the present invention. The system includes a dehalogenation unit positioned upstream and above and in-line volatization unit.

FIG. 3 shows a schematic of a chlorine removal system using the methods of the present invention. The system includes a dehalogenation unit positioned upstream and in-line with a volatization unit that includes a material moving apparatus (e.g., a conveyor).

FIG. 4 shows a schematic of a chlorine removal system using the methods of the present invention. The system includes a dehalogenation unit positioned upstream to a rotating volatization unit.

FIG. 5 shows a schematic of chlorine removal in combination with a depolymerization unit and an optional purification unit.

While the invention is susceptible to various modifications and alternative forms, specific embodiments thereof are shown by way of example in the drawings. The drawings may not be to scale.

### DETAILED DESCRIPTION OF THE INVENTION

Chemical recycle of mixed plastic waste (MPW) involves thermally treating MPW to generate hydrocarbon liquids and waxes, which are mixed with conventional hydrocarbon streams for processing in a petrochemical complex. The presence of PVC in mixed plastic waste leads to formation of organic chlorides in the MPW derived hydrocarbons and inorganic chlorides. This limits the amount of MPW that can be recycled. A solution to at least one of the problems associated with chlorine removal from MPW has been discovered. In one aspect, the invention can include processes to remove chlorine from the MPW based on separating dehalogenation of chlorine containing polymers from devolatilization of HCl in two separate unit operations. Chlorine containing polymers can be melted at a high temperature and a short residence time. The polymer melt product can be manipulated to have increased surface area (e.g., formed into strands/fibers and/or droplets). Increased surface area can provide the advantage of a high surface area for enhanced mass transfer (e.g., devolatilization) of HCl out of the fibers. In some aspects, the HCl removal can performed under vacuum or with a hot gaseous purge.

These and other non-limiting aspects of the present invention are discussed in further detail in the following sections.

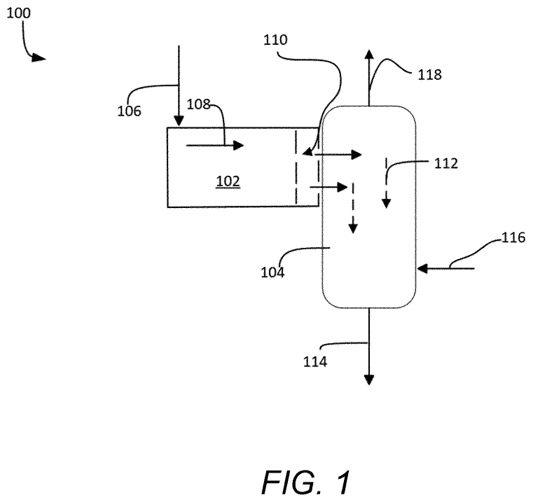

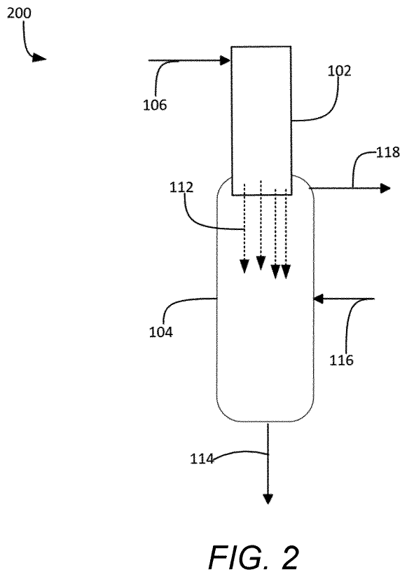

Referring to FIG. 1, system 100 includes dehalogenation unit 102 and devolatization unit 104. MPW stream 106 can enter dehalogenation unit 102. As shown, dehalogenation unit 102 can be positioned perpendicular to devolatization unit 104. Other configurations are shown in FIGS. 2-4. MPW stream 106 can include one or more non-chlorine polymers and at least one chlorine containing polymer. Non-chlorine containing polymers (e.g., a first polymer) can include polyethylene terephthalate (PET), low-density and high-density polyethylene (PE), polypropylene (PP), polystyrene (PS), or combinations thereof, and/or other miscellaneous plastics. Non-limiting examples of chlorine containing polymers include polyvinyl chloride (PVC), polyvinylidene chloride (PVDC), chlorinated polyethylene (CPE), chlorosulphonated polyethylene (CSM), or chloroendic acid polyester, or any combination or blend thereof. In a preferred aspect, the chlorine containing polymer is PVC. Other miscellaneous plastics can be present in the MPW stream such as acrylonitrile butadiene styrene found in electronic waste, polyurethane foam packaging, carpet nylon, and/or polysulfone. MPW stream 106 can also include impurities. Non-limiting examples of impurities include paper, wood, aluminum foil, some metallic conductive fillers, and/or halogenated or non-halogenated flame retardants. MPW stream can be in a solid form or in a flowable form (e.g., a viscous low-flowing material).

Dehalogenation unit 102 (a reactor) can be any unit capable of melting solid MPW. Non-limiting examples of dehalogenation units can include, an extruder, a kneader, a heat exchange unit that includes a static mixer, or a batch reactor. Non-limiting examples of extruders can include a single, or twin screw or an Auger reactor with flight geometries of either ribbon, paddles, other constructs, interrupted, or shaftless. In dehalogenation unit 102, MPW stream 106 can be heated under agitation to a temperature sufficient to melt the MPW stream. Melting temperatures can be up to 350° C., or 200° C. to 325° C., or 200° C., 225° C., 250° C., 275° C., 300° C., 325° C., 350° C., or any range or value there between. A residence time of melted MPW stream 108 in dehalogenation unit 102 depends on the temperature. Lower residence time can be used when operating at higher temperatures. For example, at 300° C., the residence time or 1 minute or lower is sufficient, whereas at 250° C. a residence time of at least 10 minutes is required. In general, the residence time can be 30 minutes or less, 25 minutes or less, 20 minutes or less, 15 minutes or less, 10 minutes or less, or 5 minutes or less, or 0.1 minute to 30 minutes, any value or range there between. The short residence time in dehalogenation unit 102 provides the advantage of limiting side reactions from HCl (formed during the melting process) reacting with the MPW stream to produce additional inorganic chlorides and organic halides. In other aspects, the residence time can be greater than 30 minutes (e.g., 35, 40, 45, 50, 55, 60, 70, 80, 90, 100, 110, 120 minutes, or more).

As melted MPW stream 108 exits dehalogenation unit 102, and enters devolatization unit 104, the surface area of the melted MPW can be increased by applying pressure to the melted MPW stream. For example, the melted MPW can pass through one or more orifices 110 to form strands/fibers or droplets 112. Formation of strands/fibers or droplets can increase the surface area of the melted MPW stream 108 and allow release of the HCl entrained in the melted polymer. Orifices can be any shape or size (e.g., round, elliptical, elongated, spherical and the like). In some embodiments, orifices are part of a die coupled to the dehalogenation unit 102. For example, dehalogenation unit can include an extruder having a die attached to the end of the extruder. In some embodiments, dehalogenation unit can be a kneader that includes a discharge die at the exit of the kneader. In another aspect, dehalogenation unit can be a heat exchanger unit with a static mixer and a discharge die at the exit of the heating exchanger. In certain aspects, dehalogenation unit can be a batch reactor that includes an discharge die. In other aspects dehalogenation unit can be a batch reactor kneader, heat exchanger with static mixer in combination with an extruder and die. Strands/fibers 112 can have a diameter of 5 mm or less or 0.1 mm to 5 mm, or 0.1 mm, 0.5 mm, 1 mm, 1.5 mm, 2 mm, 2.5 mm, 3 mm, 3.5 mm, 4 mm, 4.5 mm, 5 mm, or any value or range there between. In other aspects, the strands/fibers 112 can have a diameter greater than 5 mm, such as 6, 7, 8, 9, 10, 15, 20 mm, or more.

Strands/fibers 112 can exit orifices 110 and enter devolatization unit 104. Devolatization unit 104 can be integrated with dehalogenation unit 102 such that the strands/fibers 112 are not exposed to air (e.g., one unit with two chambers, or joined by a die). Devolatization unit 104 can be a container, a flash vessel, a wiped film evaporator, or the like that allows for removal of vapor from a vessel or reaction stream. In some aspects, devolatization unit 104 can include electrically heated mesh or sieve trays to promote heat transport. Such trays can also help support the strands/fibers 112 as they flow through devolatization unit 104. As the strands/fibers 112 are formed and enter devolatization unit 104, HCl can be released from the fibers to produce first product stream 114. In some aspects, the devolatilization unit inlet can have a splash plate, spinning disc or such on which the strand/fibers impinges and sprays out and are further carried away by carrier gas. In some embodiments, strands/fibers 112 are droplets (not shown). Droplets can have a diameter similar to the diameter of the strands/fibers. HCl can include gaseous HCl, liquid HCl, or a mixture thereof. Removal of HCl can be performed under vacuum or using a carrier gas. A vacuum pressure can be 50 to 760 mm Hg absolute, or 100, 200, 300, 500, 550, 600, 650, 700, 750, 760 mm Hg absolute or any value or range there between. gases can be inert and/or reactive gases. Inert gases can include N₂ and/or CO₂. Non-limiting examples of reactive gases can include H₂, NH₃, or scrubbed product gas (HCl free) obtained from the devolatization unit 104. A temperature of the carrier gas can be 200° C. to 450° C. or 200° C., 225° C., 250° C., 275° C., 300° C., 325° C., 350° C., 375° C., 400° C., 425° C., 450° C. or any value or range there between. As shown, the HCl vapor stream 118 outlet is positioned above carrier gas 116 inlet, thus allowing for a counter-current flow of carrier gas to sweep the HCl up and out of devolatization unit 104 as HCl vapor stream 118. HCl-containing vapor stream 118 can be further processed (e.g., scrubbed vapor stream). Devolatization temperatures can be above the melting point of the MPW. For example, devolatization temperatures can be up to 450° C., 400° C., 350° C., or 200° C. to 450° C., or 200° C., 225° C., 250° C., 275° C., 300° C., 325° C., 350° C., 400° C., 425° C., 450° C., or any range or value there between. The length of the devolatization unit 104 and/or residence time in the devolatization unit can be based on the feed rate from dehalogenation unit 102 and/or the diameter of the fibers. For example, a residence time of fibers/strands 112 in devolatization unit 104 can be 30 minutes or less, 25 minutes or less, 20 minutes or less, 15 minutes or less, 10 minutes or less, or 5 minutes or less, or 0.1 minute to 30 minutes, any value or range there between at the devolatization temperatures. First product stream 114 can exit devolatization unit and be further processed stored, transported or the like.

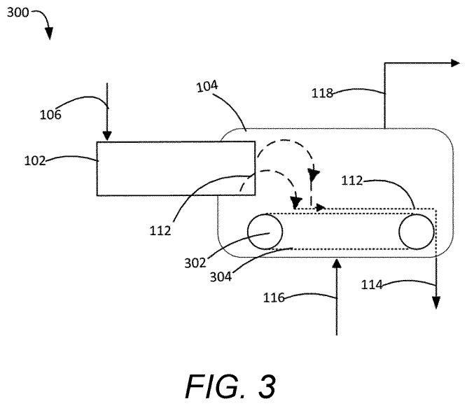

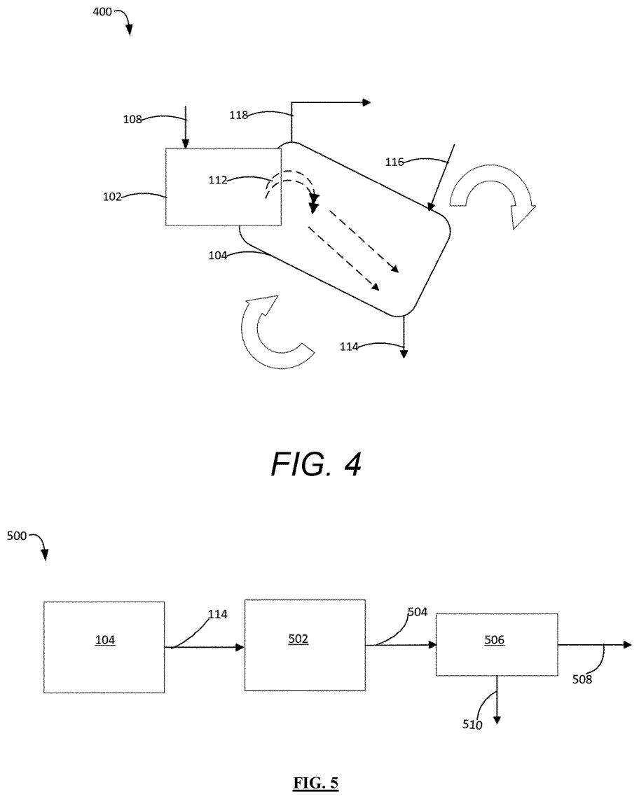

Referring to FIGS. 2, 3 and 4, variations of the configurations of the dehalogenation unit 102 and devolatization unit 104 are shown. The reference numbers from FIG. 1 are used and refer to the same streams and units unless otherwise indicated. Referring to FIG. 2, system 200 illustrates dehalogenation unit 102 positioned upstream and in-line or parallel to devolatization unit 104. For example, a vertical extruder can be positioned upstream of a vertical devolatization unit. Referring to FIG. 3, system 300 includes dehalogenation unit 102 positioned upstream and in line with devolatization unit 104, which can include conveyor unit 302. As strands/fibers 112 enter devolatization unit 104 they can contact conveyor belt 304 of conveyor unit 302 running inside of the dehalogenation unit. Conveyor belt 304 can be coated with composition that provides non-stick and release of the strands/fibers 112 at high temperatures. Non-limiting examples of non-stick/release coatings include silicone, Teflon®, and the like. Carrier gas 116 can enter devolatization unit 104 such that the flow is cross-current to the flow of polymer fibers. As shown, carrier gas 116 can be provided beneath the conveyor belt 304. The conveyor belt speed can provide control of the strands/fibers 112 residence time in devolatization unit 104. Referring to FIG. 4, system 400 includes dehalogenation unit 102 positioned upstream and in-line with a rotatable devolatization unit 104. For example, devolatization unit 104 can be rotatory kiln. The rotation speed and angle of the devolatization unit 104 can control strands/fiber 112 residence time for mass transfer of HCl. Flow of carrier gas 116 can be counter current or co-current.

Referring to FIG. 5, system 500 illustrates further processing of first product stream 114. In FIG. 5, devolatization unit of FIGS. 1-4 is in fluid communication with depolymerization unit 502. First product stream 114 can exit devolatization unit 104 and enter depolymerization unit 502. In depolymerization unit 502, first product stream 114 can be subjected to conditions suitable to depolymerize polymers in the first product stream to produce second product stream 504. Second product stream 504 can include oligomers obtained from the depolymerized polymers. Depolymerization conditions can include temperatures of 300° C. to 450° C., or 300° C., 325° C., 350° C., 375° C., 400° C., 425° C., 450° C. or any value or range therebetween and pressure of 0.5 MPa or less including vacuum. Second product stream 504 can include, in addition to oligomers, impurities. Non-limiting examples of impurities can include insoluble materials, soluble organic materials, inorganic chlorides or a combination thereof. Second product stream 504 can exit depolymerization unit 502 and enter purification unit 506. In purification unit 506, second product stream 504 can be further processed to remove the impurities. Non-limiting examples of purification methods can include filtration, centrifugation, decanting/sedimentation, washing with water or caustic solution, and/or combinations thereof.

Systems 100-500 can include one or more heating and/or cooling devices (e.g., insulation, electrical heaters, jacketed heat exchangers in the wall) or controllers (e.g., computers, flow valves, automated values, etc.) that can be used to control temperatures, pressures and fluid flow of the units. While only one unit is shown, it should be understood that multiple units (e.g., multiple devolatization units or multiple dehalogenation units) can be used.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A method of removing chlorine from a mixed plastic waste comprising a first polymer and a second chlorine containing polymer, the method comprising:
(a) heating the mixed plastic waste to obtain a melted mixed plastic waste stream comprising melted plastic and hydrogen chloride (HCl); and
(b) increasing the surface area of the melted mixed plastic waste stream to release at least a portion of the HCl from the melted mixed plastic waste stream and to produce a first product stream comprising less chlorine when compared with the mixed plastic waste from step (a).

2. The method of claim 1, wherein increasing the surface area of the melted mixed plastic waste stream comprises forming strands/fibers or droplets of the melted mixed plastic waste stream.

3. The method of claim 1, wherein step (a) is performed, at least in part, in an extruder, a kneader, or a heat exchange unit comprising a static mixer, or batch reactor, and step (b) is performed, at least in part, in a container that is in fluid communication with the extruder, a kneader, or a heat exchange unit comprising a static mixer, or batch reactor.

4. The method of claim 3, wherein a die is positioned at an end of the extruder, the kneader, or the heat exchange unit, and wherein the melted mixed plastic waste stream flows through the die and into the container to form strands/fibers or droplets of the melted mixed plastic waste stream.

5. The method of claim 3, wherein step (a) is performed in the extruder, and wherein the extruder is a single screw extruder, a twin screw extruder, or an auger extruder.

6. The method of claim 1, wherein steps (a) and (b) are each individually performed at least at a melt temperature of the mixed plastic waste up to 350° C.

7. The method of claim 1, wherein step (b) is performed in the presence of a carrier gas that contacts the melted mixed plastic waste stream and carries the HCl away from the melted mixed plastic waste stream.

8. The method of claim 7, wherein step (b) is performed in a reactor comprising:
a first inlet for the melted mixed plastic waste stream;
a second inlet for the carrier gas;
a first outlet for the first product stream; and
a second outlet for the carrier gas comprising the HCl obtained from the chlorine containing polymer,
wherein the second outlet is positioned above the first outlet.

9. The method of claim 8, wherein step (a) is performed in an extruder, and wherein the extruder is a horizontal extruder or a vertical extruder, and wherein the extruder is positioned above the first outlet for the first product stream.

10. The method of claim 8, wherein the reactor includes a conveyer belt, and wherein the melted mixed plastic waste stream from step (b) is contacted with the conveyer belt or wherein the reactor is capable of rotating.

11. The method of claim 1, wherein the first product stream is subjected to a depolymerization reaction to produce a second product stream comprising oligomers.

12. The method of claim 11, wherein the second product stream is further processed to remove insoluble materials, soluble organic materials, inorganic chlorides or a combination thereof by filtration, centrifugation, or washing with water or caustic solution.

13. The method of claim 1, wherein:
the first polymer comprises polyethylene (PE), polypropylene (PP), polyethylene terephthalate (PET), or polystyrene (PS), or any combination or blend thereof; and
the second chlorine containing polymer comprises polyvinyl chloride (PVC), polyvinylidene chloride (PVDC), chlorinated polyethylene (CPE), chlorosulphonated polyethylene (CSM), or chloroendic acid polyester, or any combination or blend thereof.

14. The method of claim 13, wherein the second chlorine containing polymer is PVC.

15. A system to perform the method of claim 1, the system comprising:
an extruder configured to produce the melted mixed waste plastic stream comprising the melted plastic and HCl;
a die in fluid communication with the extruder, the die capable of forming strands/fibers or droplets of the melted mixed plastic waste stream; and
a container in fluid communication with the die, the container configured to remove HCl from the melted mixed plastic waste stream.
